(19) United States
(12) Patent Application Publication
(10) Pub. No.: US 2009/0172180 A1
(43) Pub. Date: Jul. 2, 2009

(54) Apparatus And Method For Transmitting Streaming Services

(76) Inventors: Ji-Feng Chiu, Kaohsiung (TW); Yu-Ben Miao, Tainan (TW); Chia-Ming Lu, Taipei (TW); Yun-Shuai Yu, Changhua (TW); Tzu-Chi Huang, Tainan (TW); Ce-Kuan Shieh, Tainan (TW)

Correspondence Address: LIN & ASSOCIATES INTELLECTUAL PROPERTY, INC., P.O. BOX 2339, SARATOGA, CA, 95070-0339, US

(21) Appl. No.: 12/120,232

(22) Filed: May 14, 2008

(30) Foreign Application Priority Data
Dec. 31, 2007 (TW) 096151602

(51) Int. Cl. G06F 15/16

(52) U.S. Cl. 709/231

(57) ABSTRACT

Disclosed is a system and method for transmitting streaming services. The system may comprise a service agent having a service list. The service list records the contact addresses and priority for one or more nodes that can provide streaming services. The priority for a node represents the level that the node belongs to a path for transmitting streaming data. When a client node requests the service agent for the nodes, wherein the nodes may provide a specific streaming service, the service agent searches for the service list and responds the search result to the client node. Therefore, the client node may get the streaming data directly from the nodes being found, and these nodes form a peer-to-peer network system.

### FIELD OF THE INVENTION

The present invention generally relates to an apparatus and method for transmitting streaming service, applicable to peer-to-peer (P2P) network communications.

### BACKGROUND OF THE INVENTION

The contents transmitted over Internet have evolved from pure text to multimedia in the last decades. The recent streaming services gain popularity over the years, and more and more technologies are developed for accelerating the delivery of streaming services to the clients.

For example, U.S. Pat. No. 6,484,212 disclosed a video Proxy server. The server stores streaming data and receives from the user the request regarding streaming data. If the user requests the context that is not stored on the server, the server will send the request to the source of the streaming data and stores the data to the video proxy server. U.S. Patent Publication 2006/0184,688 disclosed a local proxy streaming server, including a scheduling module that may access streaming data in parallel from a plurality of media sources, and a transmission rate monitoring module to control the transmission rate.

The aforementioned servers require storage space to store the media contents or streaming data. When the number of users increases, the servers and the data sources may experience scalability problem.

To prevent the server in the client-server architecture from becoming the bottleneck, much research proposes the peer-to-peer, or application level multicast techniques. FIG. 1 shows a schematic view of an exemplary peer-to-peer architecture of application level multicasting tree. In the exemplary peer-to-peer architecture of FIG. 1, each peer is located at a level in the streaming data transmission path from peer 100 to peer 112.

U.S. Patent Publication 2007/0,127,481 disclosed a streaming service in a P2P network. Each peer in the network has a streaming providing mechanism, including a content transmission unit, a content receiving unit and a storage unit for transmitting, receiving streaming data and error detection, and storing content, respectively. Hence, it requires time to search for the peer with requested streaming data. If the peer is located at a remote place, the streaming quality is affected.

V. N. Padmanabhan, et. al. presented a paper “The Case for Cooperative networking” in 2003. The paper proposed an inexpensive and yet effective solution for the flash crowd problem. The solution employs a centralized management serving mechanism. When the server is overloaded, the client will provide the downloaded contents to another client. By using the end-hosts cooperate mechanism to decentralized the server's load and to compensate the weakness of the server-client architecture to improve the network efficiency. This technique requires 3 transaction processes in the initial delay.

Paul Francis et. al. presented a paper “YOID: Your Own Internet Distribution”, describing the Yoid application-level multicast system architecture, and minimizing the coordination of the inter-tree node. According to the observed loss and latency performance, the tree may be repaired rapidly and the tree performance may be continuously improved. The technique uses a rendezvous host to automatically allocate and maintain the application level overlay tree. This technique requires at least 3 transaction processes in the initial delay.

Therefore, it is imperative to apply the peer-to-peer technology to the rapid transmission of streaming data to the client.

### SUMMARY OF THE INVENTION

The exemplary embodiments according to the present invention may provide an apparatus and method for transmitting streaming services. The streaming service transmission technique uses service agent to provide the client with the information on the nodes that can provide streaming service so that the client may retrieve the streaming data from the nearby node.

In an exemplary embodiment of the present invention, the disclosed is directed to an apparatus for transmitting streaming services, applicable to a network communication environment. The apparatus may comprise a service agent having a service list. The service list records the contact addresses and the priority for one or more nodes that may provide streaming services. The priority for a node represents the level that the node belongs to a path for transmitting streaming data. When a client node requests the service agent for the nodes that may provide a specific streaming service, the service agent searches for the service list and responds the search result to the client node. Therefore, the client node may get the streaming data directly from the nodes being found, and these nodes form a peer-to-peer network system.

In another exemplary embodiment of the present invention, the disclosed is directed to a method for transmitting streaming services, comprising: arranging a service agent having a service list recording the contact address of at least a node and the priority for one or more nodes able to provide streaming services; and the client node requesting the service agent for the nodes able to provide a specific streaming service and getting the streaming data directly from the nodes being found.

In the disclosed embodiments, the service proxy may accept the registration of nodes that may provide streaming service, or cancel the registration of nodes. The registration of a node may be cancelled when the node leaves the network or the number of nodes that may provide streaming services reaches the upper bound. When a node is cancelled, the recorded information will be deleted from the service list.

The foregoing and other features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a schematic view of an exemplary peer-to-peer architecture of application level multicasting tree.

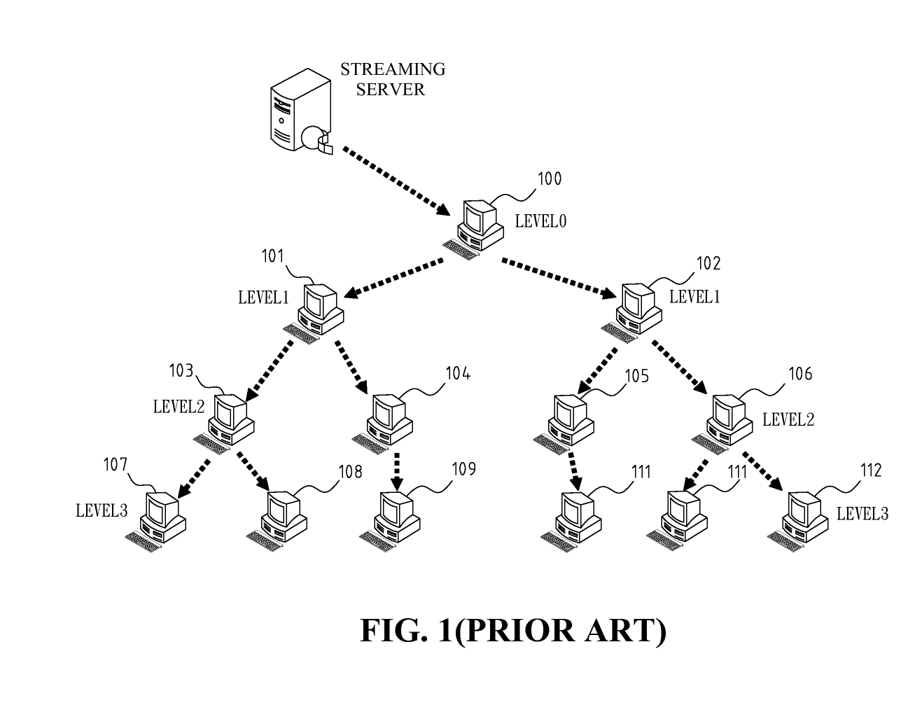

FIG. 2A shows a schematic view of an exemplary apparatus for transmitting streaming services, consistent with certain disclosed embodiments.

FIG. 2B shows an exemplary service list, consistent with certain disclosed embodiments.

FIG. 3a shows an exemplary schematic view of the interaction between service agent and the components of the communication environment when service agent receiving the first request of the provision of a streaming service, consistent with certain disclosed embodiments.

FIG. 3B shows an exemplary schematic view of the initial construction of the streaming service in the service list, consistent with certain disclosed embodiments.

FIG. 4A shows an exemplary schematic view of the interaction between service agent and the components of the communication environment when service agent receiving another request of the provision of a streaming service, consistent with certain disclosed embodiments.

FIG. 4B shows an exemplary schematic view of the construction of the streaming service in the service list, consistent with certain disclosed embodiments.

FIG. 5A shows an exemplary schematic view of the interaction between service agent and the components of the communication environment when service agent receiving yet another request of the provision of a streaming service, consistent with certain disclosed embodiments.

FIG. 5B shows an exemplary schematic view of the construction of the streaming service in the service list, consistent with certain disclosed embodiments.

FIG. 6 shows an exemplary situation that service list does not have any available entry for the registration of new node, consistent with certain disclosed embodiments.

FIG. 7A shows an exemplary situation that when a node informs service agent that the maximum number of the nodes providing the streaming service is reached, the node is deregistered, consistent with certain disclosed embodiments.

FIG. 7B shows an exemplary schematic view of canceling the registration of a node, and the entry of the node is deleted from service list, consistent with certain disclosed embodiments.

FIG. 7C shows an exemplary service list after updating the service list of FIG. 7A, consistent with certain disclosed embodiments.

FIG. 8A shows an exemplary schematic view that a node departs a network in a peer-to-peer architecture of application level multicasting tree, consistent with certain disclosed embodiments.

FIG. 8B shows an exemplary schematic view of re-constructing a new multicast tree after a departing node being canceled registration, consistent with certain disclosed embodiments.

FIG. 9 shows an exemplary flowchart of the method for transmitting streaming service, consistent with certain disclosed embodiments.

FIG. 10 shows an exemplary flowchart of the method for transmitting streaming service when a node departs from the network, consistent with certain disclosed embodiments.

### DETAILED DESCRIPTION OF THE PREFERRED EMBODIMENTS

The exemplary embodiments of the present invention provide a streaming service transmission technique. The streaming service transmission technique uses service agent in the peer-to-peer network to provide the client node with the address of the node having the requested streaming data so that the client node does not require to retrieve the streaming data from the source node that provides the streaming data, and the service agent does not require to store the streaming data. The service agent maintains a service list recording the contact address of one or more nodes that may provide the streaming service, and the priority of each node on the streaming data transmission path. For example, a channel ID may be used to record the contact address of the nodes able to provide streaming service on this channel and the corresponding priority. An upper bound may also be set for the number of nodes able to provide the streaming service.

Hence, service agent may rapidly respond to the nodes requesting streaming service and reduces the depth of the constructed application-level multicast tree in the network so that the streaming data may be accessed rapidly and network traffic load is distributed.

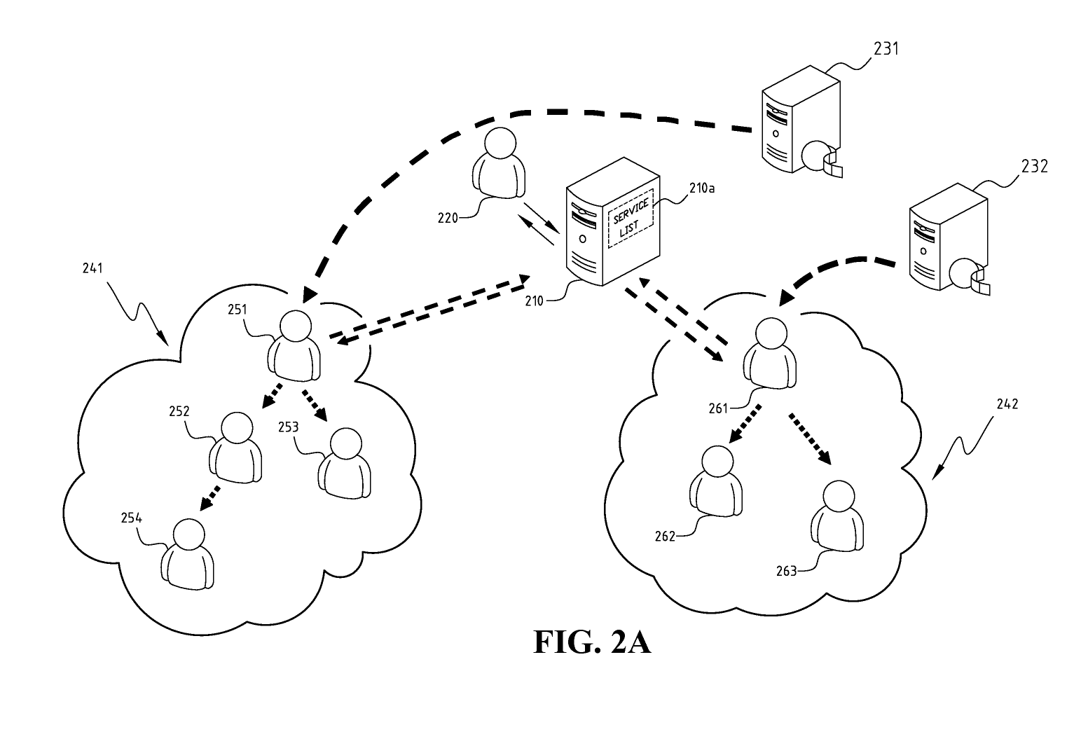

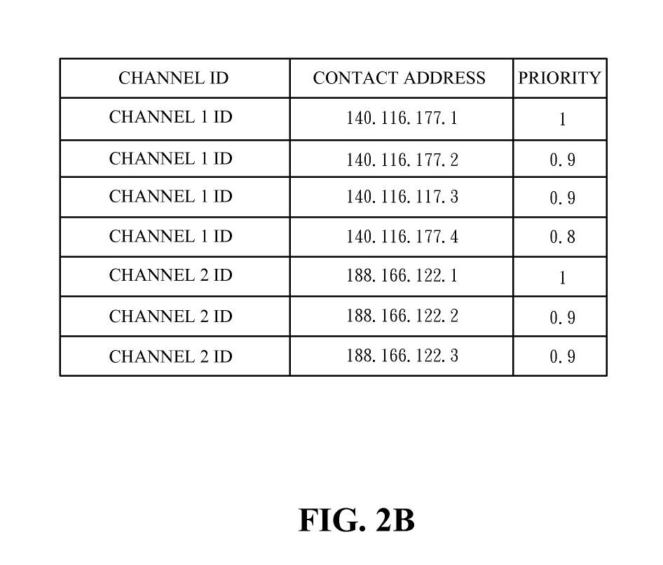

FIG. 2A shows a schematic view of an exemplary apparatus for transmitting streaming services, consistent with certain disclosed embodiments. The network transmission system is applicable to network communication environments to provide the client node the contact address of the streaming data. Referring to FIG. 2A, the apparatus comprises a service agent 210 with a service list 210a. FIG. 2B shows an exemplary service list 210a, consistent with certain disclosed embodiments.

Refer to FIGS. 2A-2B. When a client node 220 in an network inquires to service agent 210 of the contact address of the node able to provide streaming data, service agent 210 searches service list 210a and replies the search result to client node 220 so that client node 220 may request directly to the node able to provide streaming data. Also, the nodes from the search result form a peer-to-peer network. Service list 210a records the contact address of one or more nodes able to provide streaming service, and the priority of each node on the streaming data transmission path. The following description refers to the exemplary service list 210a of FIG. 2B.

Assume that service list 210a of FIG. 2B records the contact addresses of nodes that may provide streaming services in two channels, such as channel 1 and channel 2, and the priority of each node on the streaming data transmission path. In channel 1, four nodes 251-254 may provide first streaming server 231 with streaming data. In channel 2, three nodes 261-263 may provide second streaming server 232 with streaming data. The contents of the exemplary service list 210a show the channel 1 ID, contact addresses of nodes 251-254, priority of each node on the streaming data transmission path, the channel 2 ID, contact addresses of nodes 261-263, and priority of each node on the streaming data transmission path.

For example, the contact addresses for nodes 251-254 in channel 1 are 140.116.177.1, 140.116.177.2, 140.116.177.3, and 140.116.177.4. Nodes 251-254 form a peer-to-peer network 241. The priorities corresponding to each of nodes 251-254 are 1, 0.9, 0.9 and 0.8, respectively. The contact addresses for nodes 261-263 in channel 2 are 188.166.122.1, 188.166.122.2, and 188.166.122.3. Nodes 261-263 form a peer-to-peer network 242. The priorities corresponding to each of nodes 261-263 are 1, 0.9, and 0.9 respectively. The contact addresses and corresponding priorities are recorded in service list 210a, as shown in FIG. 2B.

When client node 220 inquires service agent 210 of nodes of first streaming server 231 able to provide streaming data, service agent 210 may respond rapidly to client node 220 by using service list 210a.

Therefore, client node 220 may retrieve streaming data from a nearby node, such as node 251, instead of from the source node, such as first streaming server 231. Service agent 210 does not require storing the streaming data, either. Therefore, the streaming data may be rapidly delivered, quality improved and network traffic reduced.

Assume that network transmission system is applied to a peer-to-peer communication network, and the network communication environment includes a streaming server providing original streaming service. The following describes the initial construction and dynamic updating of service list 210a, and the interaction between service agent 210 and the components of the communication environment.

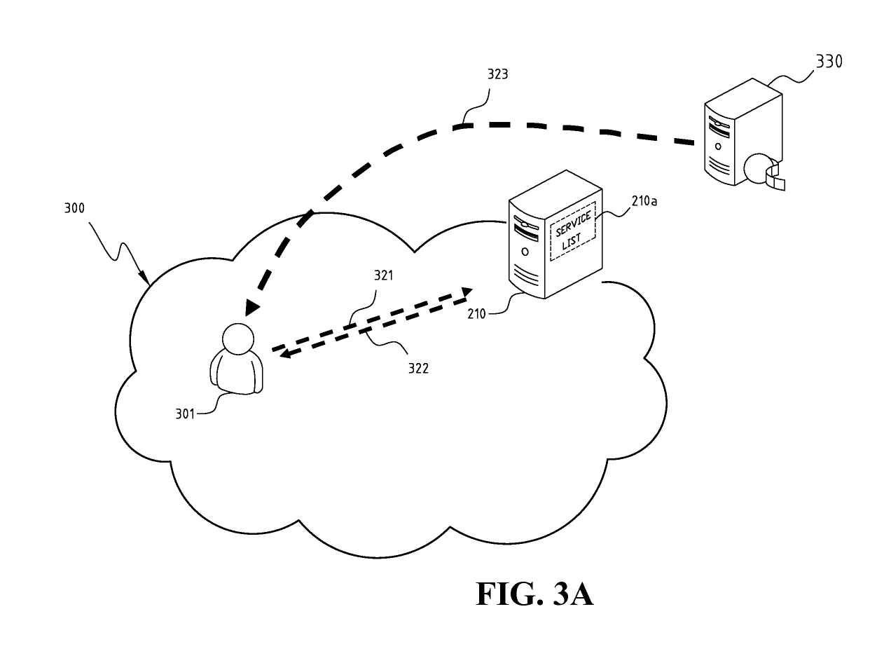

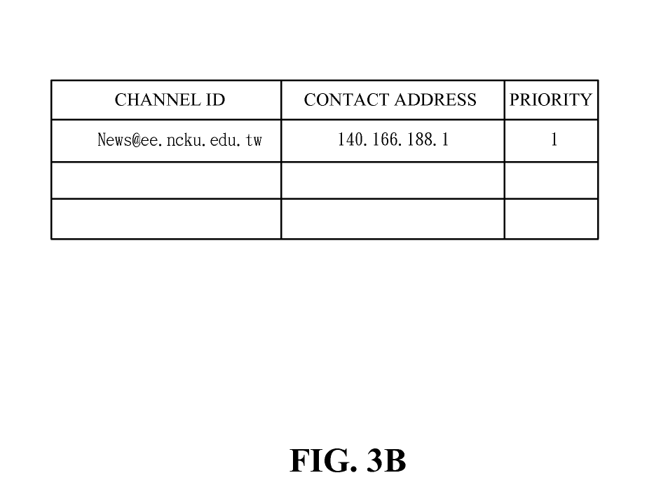

FIG. 3A and FIG. 3B show the interaction between service agent and the components of the communication environment when service agent receiving the first request of the provision of a streaming service, and the initial construction of the streaming service in the service list, respectively, consistent with certain disclosed embodiments.

Referring to FIG. 3A, assume that node 301 requests to service agent 210 of the nodes able to provide the streaming service, marked as 321, and there is no existing node receives the streaming service. Therefore, as shown by mark 322, service agent 210 responds to node 301 that no prior nodes receiving the streaming service. Node 301 receives streaming data from server 330 providing original streaming service, marked as 323, and registers to service agent 210 and records the information that node 310 may provide this streaming service. Service agent 210 records node 301 as the root node of the multicast streaming tree.

FIG. 3B shows an example recorded in service list 210a of service agent 210, where News@ee.ncku.edu.tw is the universal resource locator (URL) of the channel of the original streaming, 140.166.188.1 is the contact address of node 301 that may provide this streaming service, with priority q. Priority q reflects the level of a node in a multicast streaming tree. The higher the level is, the higher the corresponding q is. Because node 301 is the root node of the multicast streaming tree, the q of node 301 is 1, indicating the highest level.

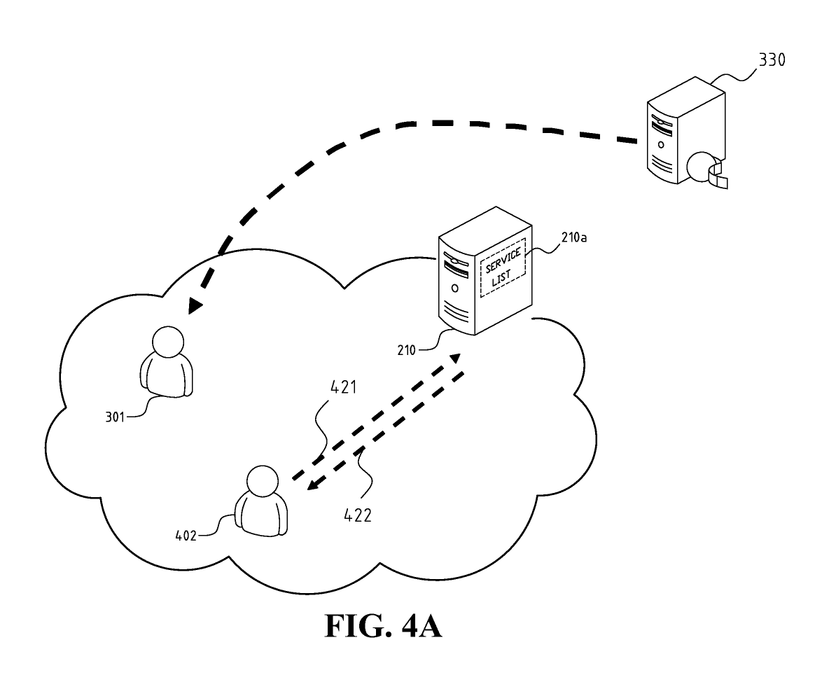

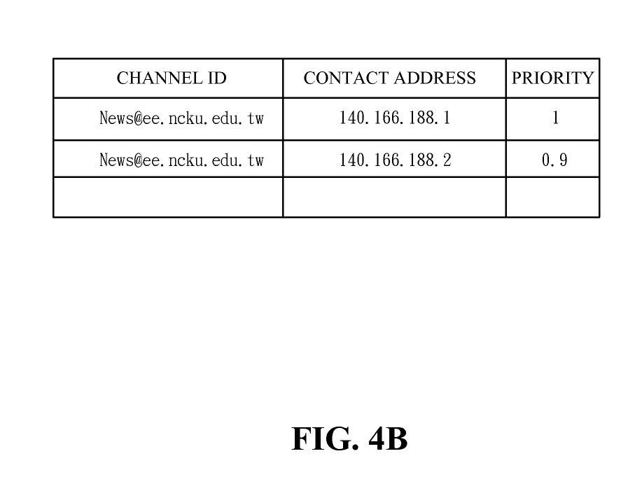

FIG. 4A and FIG. 4B show the interaction between service agent and the components of the communication environment when service agent receiving another request of the provision of a streaming service, and the construction of the streaming service in the service list, respectively, consistent with certain disclosed embodiments.

Referring to FIG. 4A, when node 402 joins the network and inquires to service agent 210 of the nodes providing the streaming service, node 402 finds that node 301 may provide the same streaming service. Therefore, node 402 requests to root node 301 of the streaming service, and establishes the second level of the multicast streaming tree. Node 402 must request to service agent 210 for registration, marked as 421, until service agent 210 responds with a registration success, marked as 422. Also, service agent 210 must record the information that node 402 provides the streaming service. FIG. 4B shows an example recorded in service list 210a of service agent 210, where 140.166.188.2 is the contact address of node 402, which is able to provide the streaming service, with priority 0.9 and as the second level of the multicast streaming tree. Instead of receiving the streaming data from original streaming server 330, node 402 may receive the streaming data from nearby node 301.

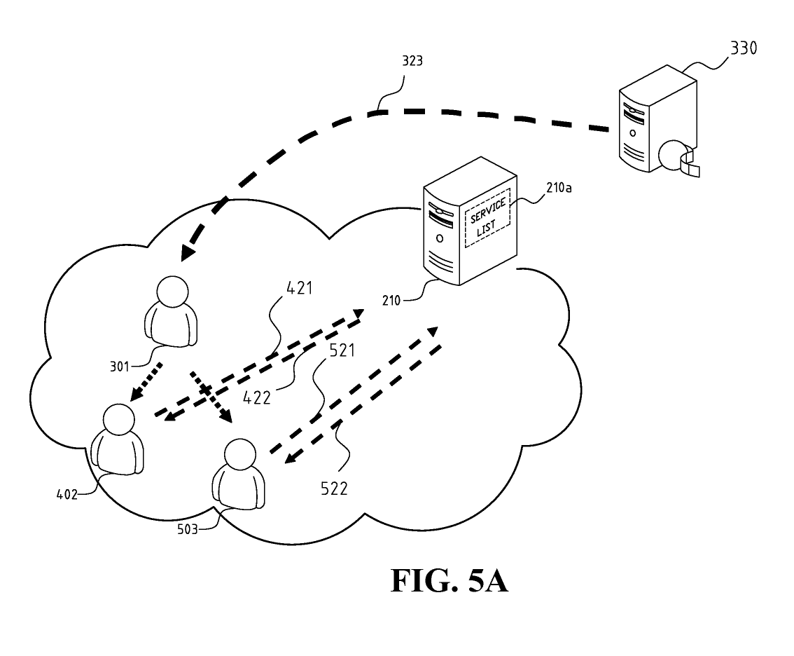

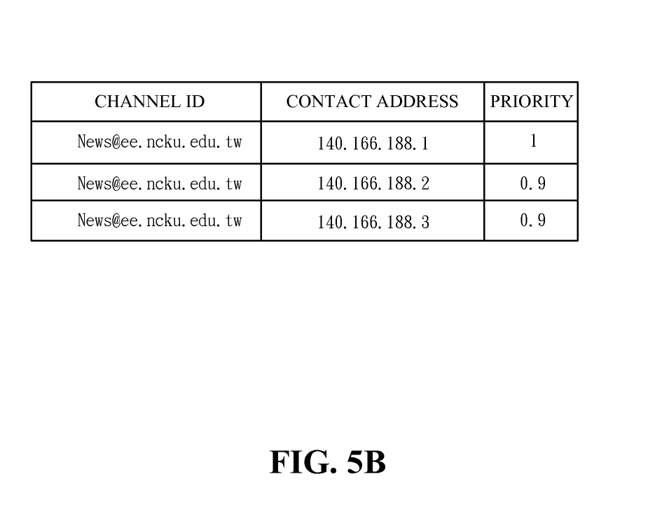

FIG. 5A and FIG. 5B show the interaction between service agent and the components of the communication environment when service agent receiving yet another request of the provision of a streaming service, and the construction of the streaming service in the service list, respectively, consistent with certain disclosed embodiments.

Referring to FIG. 5A, node 503 joins the network and inquires to service agent 210 of the nodes providing the streaming service. Similar to FIGS. 4A and 4B, node 503 may be added to the second level of the multicast streaming tree, requests to service agent 210 for registration, until service agent 210 responds with a registration success. In this manner, contact address 140.166.188.2 of node 503 with priority 0.9 may be recorded in service list 210a, as shown in FIG. 5B.

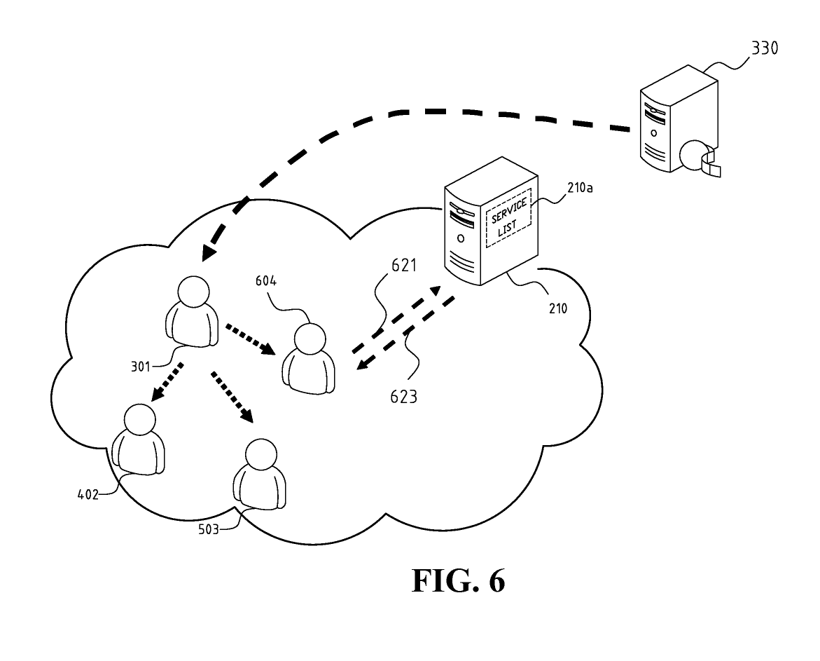

If the service agent receives another request of provision of streaming service and service list 210a does not have any available entry for the registration of new node, the scenarios is shown in FIG. 6. Referring to FIG. 6, node 604 joins the network and inquires to service agent 210 of the nodes providing the streaming service, similar to FIG. 4A and FIG. 4B. Node 604 joins the second level of the multicast streaming tree.

Then, node 604 requests to service agent 210 for registration, marked as 621. As the maximum number of the nodes able to provide the streaming service on channel with URL News@ee.ncku.edu.tw is 3, service agent 210 rejects the registration request of node 604, marked as 623.

If service list 210a has no available entry, node 604 must compute the waiting time based on priority 0.9, and according to the waiting time to periodically send request to service agent 210 until the registration succeeds. In the present invention, the waiting time depends on the corresponding priority of the level of the multicast streaming tree to which the node belongs. The higher the priority is, the shorter the waiting time is, which implies that the registration is more likely to succeed.

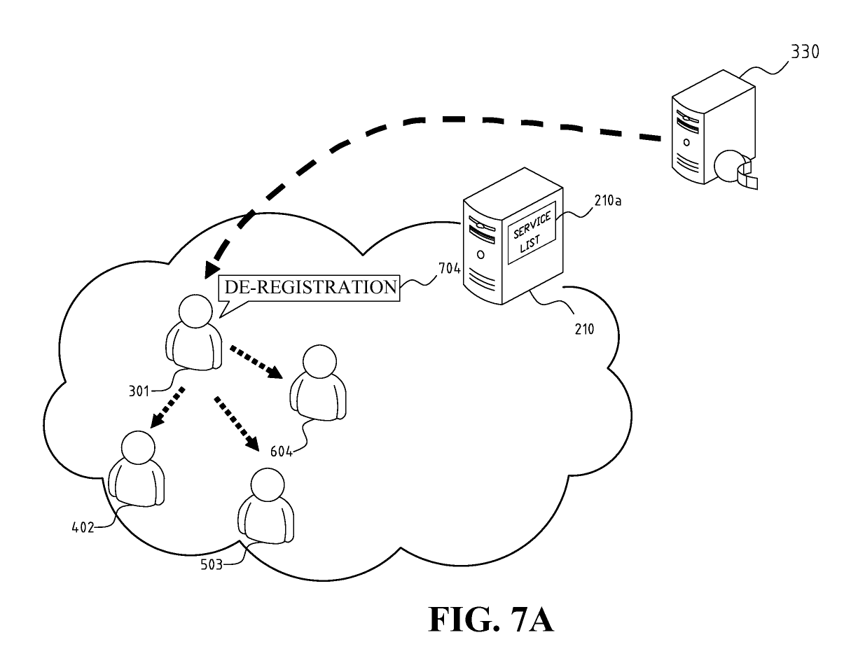

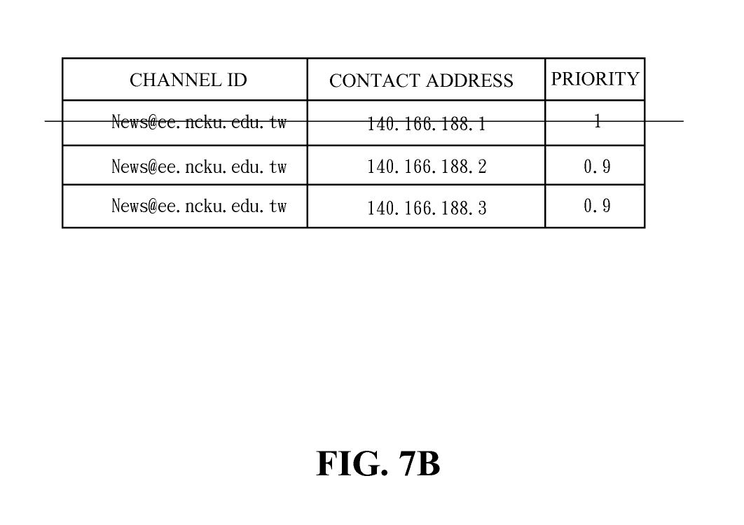

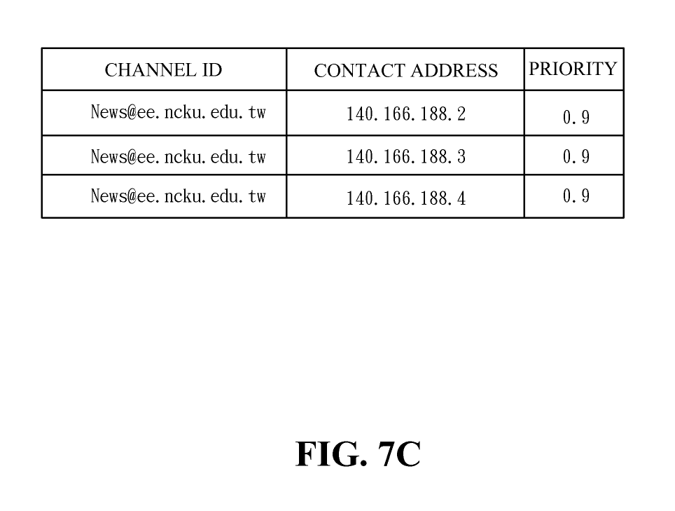

As shown in FIG. 7A, when node 301 informs service agent 210 that the maximum number of the nodes providing the streaming service is reached, and no streaming service may be provided to new node, root node 301 will send a deregistration message to service agent 210. After service agent 210 receives the deregistration message, service agent 210 will cancel the registration of node 301, as marked by 704, and the entry of node 301 is deleted from service list 210a to make available entry for other nodes, as shown in FIG. 7B.

During service list 210a making available entry, node 604 periodically registers to service agent 210 until the registration succeeds. Therefore, service agent 210 updates the service list of FIG. 7B, and adds the contact address 140.166.188.4 of node 604 with priority 0.8 to the service list. The updated service list is shown in FIG. 7C. As shown in FIG. 7C, updated service list 210a includes the contact addresses and priorities of three nodes 402, 503, 604.

The following describes how the disclosed system of the present invention handles the nodes served by a departing node when a node departs.

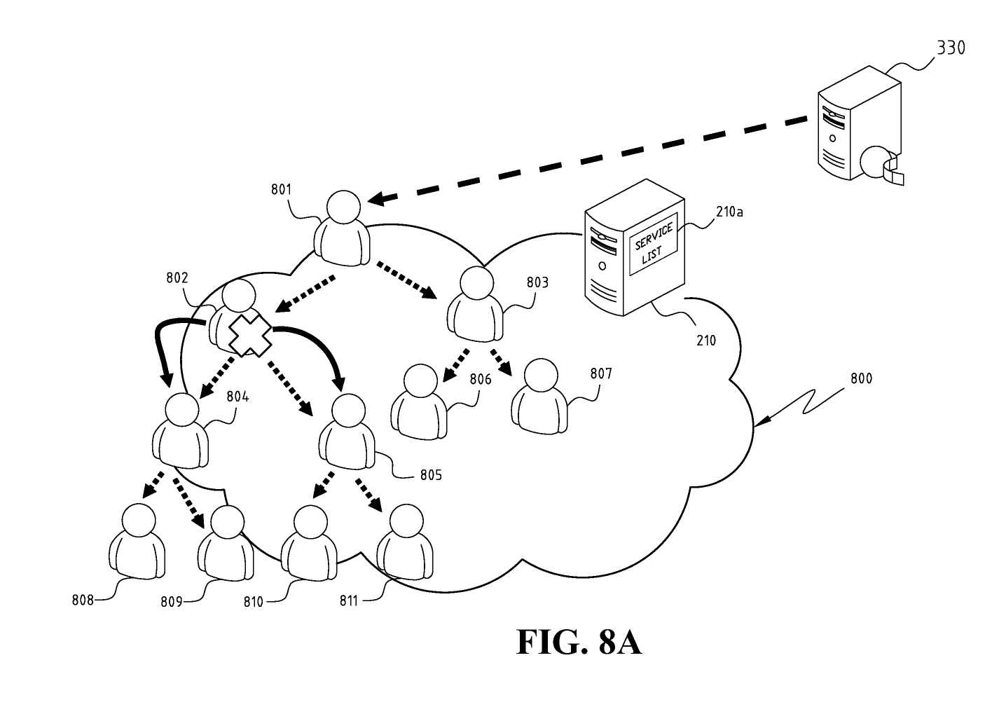

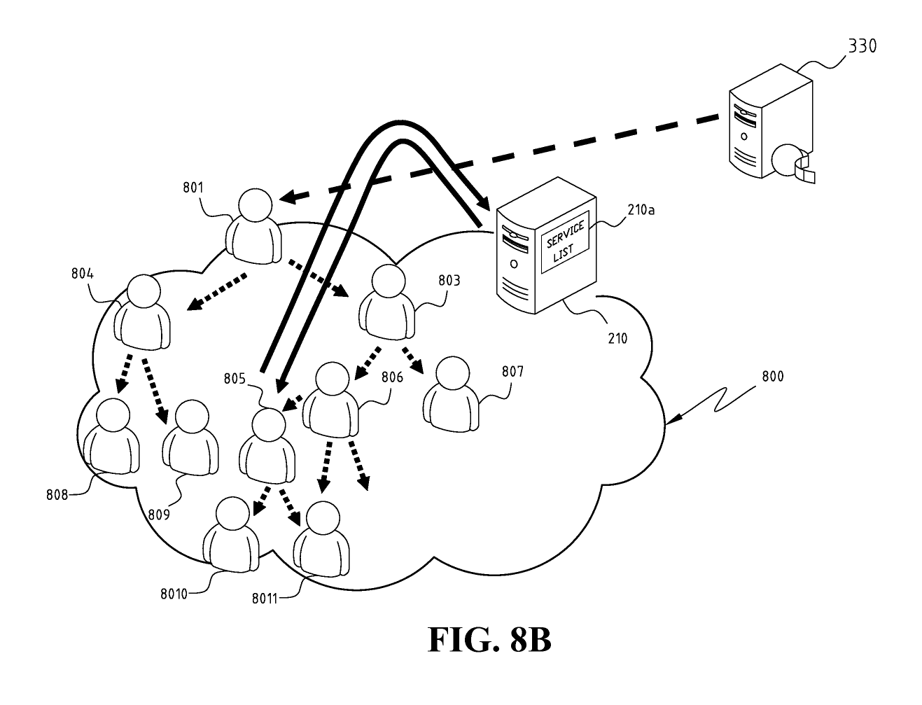

Referring to FIG. 8A, the P2P network architecture of application-level multicast tree 800 at least include nodes 801-811, and node 802 departs from the network. Nodes 804, 805 are originally served by node 802. According to the present invention, a node, such as node 804, is randomly selected from the nodes that are originally served by departing node 802 to assume the responsibility of receiving the content transmitted to departing node 802.

Also, assume that the other nodes that are not selected, such as node 805, has a corresponding priority 0.8, and the maximum number of nodes for News@ee.ncku.edu.tw channel in service list 210a is 3. Node 805 inquires to service agent 210 of the contact addresses and corresponding priorities of nodes, such as node 806, 807, that can continue to provide streaming service. The corresponding priority (0.8) of nodes 806, 807 in the multicast tree they belong to is greater or equal to the priority (0.8) of node 805 as to avoid forming a loop and the streaming service cannot be delivered. In other words, node 805 may be connected beneath to node 806 or node 807 to construct a new multicast tree.

Therefore, the unselected nodes may be connected beneath to the node that may continue to provide streaming service, and the priority of the node that may continue to provide streaming service must be higher than or equal to the priorities of the unselected nodes.

If no priority of any node is greater than the priority of the node intending to connect, all the nodes connected beneath to the departing node are disassembled and search to find new node for connection to construct a new multicast tree.

FIG. 8B shows an exemplary schematic view of re-constructing a new multicast tree after departing node 802 cancelling registration, consistent with certain disclosed embodiments. Referring to FIG. 8B, if node 805 intends to connect beneath to node 806 to re-construct a multicast tree, node 805 must send a de-registration message to service agent 210 when service list 210a does not have the entry with the contact address and the priority for the node 805. After receiving the deregistration message, service agent 210 cancels the registration of node 805, and then node 805 is re-connected beneath to node 806 to re-construct the multicast tree.

For selected node 804, a level refresh is performed on the level that node 804 belongs to, and selected node 804 is re-connected beneath root node 801 where departing node 802 is originally connected to.

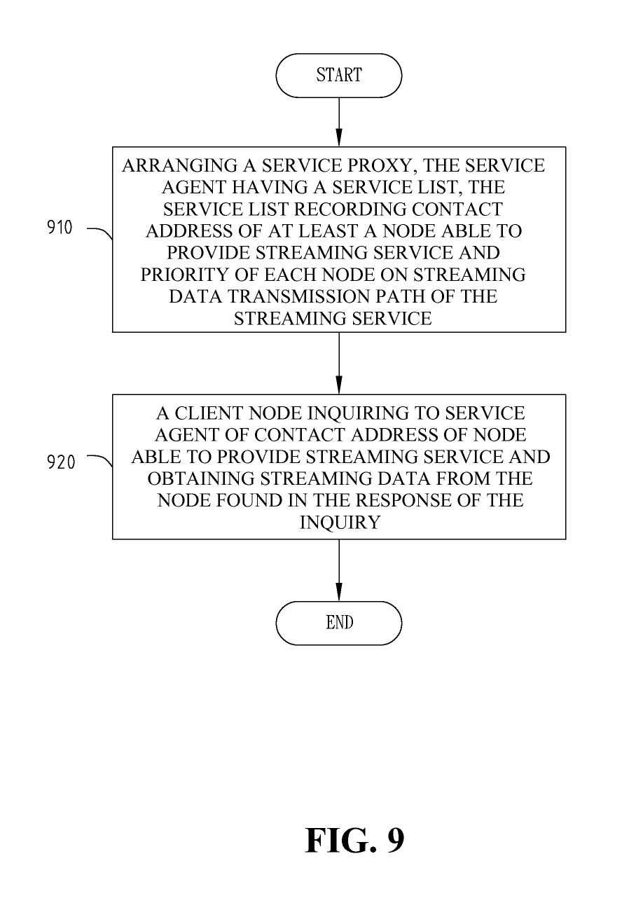

FIG. 9 shows an exemplary flowchart of the method for transmitting streaming service, consistent with certain disclosed embodiments. Referring to FIG. 9, in step 910, a service agent is arranged. The service agent has a service list recording the contact address of one or more nodes able to provide the streaming service and the priority of each node on the streaming data transmission path. The client node inquires to the service agent of the nodes able to provide the streaming data, and to get streaming data from the nodes resulted in the inquiry, as shown in step 920.

Therefore, the method for transmitting streaming service may also use the service agent to accept the registration of the nodes able to provide streaming service, to cancel the registration of departing nodes, and to cancel the registration of nodes when reaching the maximum number of nodes. As aforementioned, when a node fails in registration, a waiting time is computed according to the priority. When the registration of a node is cancelled, the corresponding entry of the node in the service list is also deleted.

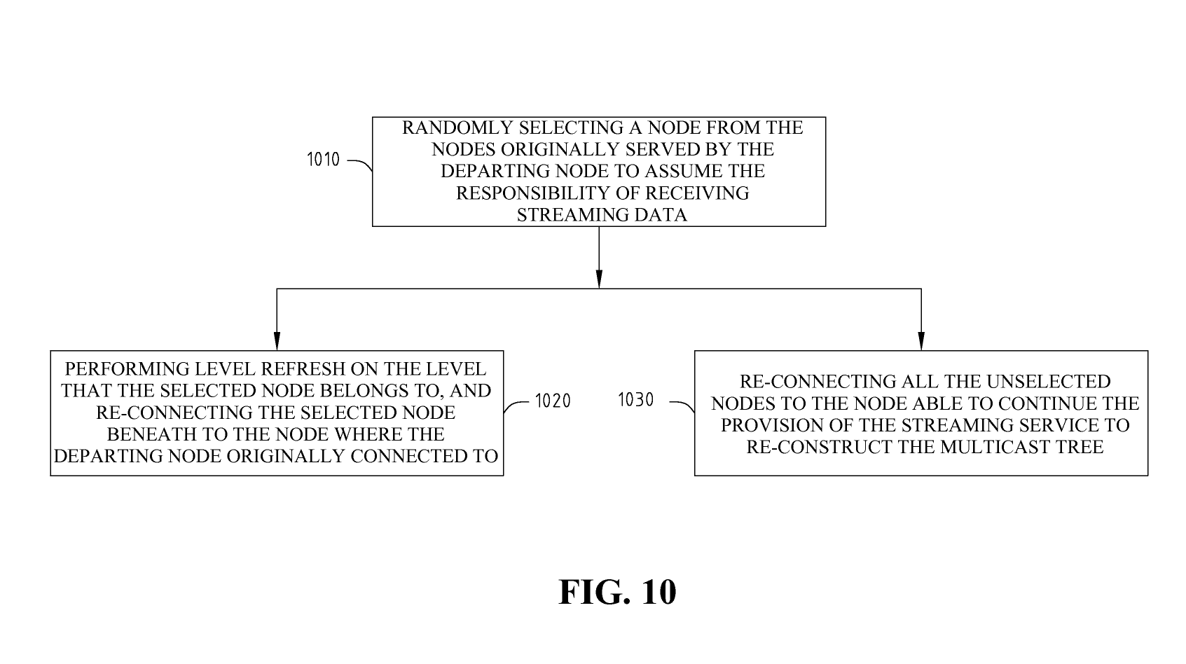

FIG. 10 shows an exemplary flowchart of the method for transmitting streaming service when a node departs from the network, consistent with certain disclosed embodiments. Referring to FIG. 10, in step 1010, a node is randomly selected from the nodes originally served by the departing node to assume the responsibility of receiving streaming data. In step 1020, level refresh is performed on the level that the selected node belongs to, and the selected node beneath to the node where the departing node originally connected to is re-connected. In step 1030, all the unselected nodes are re-connected to the node able to continue the provision of the streaming service to re-construct the multicast tree. The priority of the node able to continue the provision of the streaming service must be greater or equal to the priorities of all the unselected nodes.

When applying the present invention to the simulation of a sub-multicast tree on the session initial protocol (SIP) domain. The simulation environment includes 4 registrations, 4-10 uniform distributions, 1200 nodes added to the sub-multicast tree. The simulation results show that the present invention requires three process times in the initial delay, and may construct a zero stabilization overhead balanced tree with 1200 nodes with depth of 4. It is worth noting that the present invention does not use centralized server mechanism to achieve the P2P topology maintenance.

Although the present invention has been described with reference to the exemplary embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An apparatus for transmitting streaming service, applicable to a network communication environment, said apparatus comprising:
a service agent having a service list, said service list recording contact address of at least a node able to provide streaming service and priority of each of said at least a node on streaming data transmission path of said streaming service;
wherein when a client node inquiring to said service agent of said contact address of said at least a node able to provide streaming service, said service agent searching said service list to find said contact address and responding to said client node so that said client node able to obtaining said streaming data from said node found in the response.

2. The apparatus as claimed in claim 1, wherein all the nodes found in said search form a peer-to-peer network.

3. The apparatus as claimed in claim 1, wherein said streaming data transmission path forms a multicast tree architecture, and said the priority of each of said at least a node represents the level of said node in said multicast tree.

4. The apparatus as claimed in claim 1, wherein said service agent is responsible for receiving registration request of said nodes able to provide streaming service.

5. The apparatus as claimed in claim 2, wherein when a node departs from said peer-to-peer network, said departing node sends a deregistration message to said service agent.

6. The apparatus as claimed in claim 5, wherein when said service agent receives said deregistration message, a corresponding entry of said departing node in said service list is deleted.

7. The apparatus as claimed in claim 6, wherein a node from all the nodes served by said departing node is randomly selected to assume said responsibility for receiving contents originally delivered to said departing node.

8. The apparatus as claimed in claim 7, wherein unselected nodes are re-connected beneath to the node able to provide streaming service, and said priority of the node able to provide streaming service is greater than or equal to said priorities of all said unselected nodes.

9. The apparatus as claimed in claim 2, wherein when a node able to provide streaming service no longer provides streaming service to new nodes, said node sends a deregistration message to said service agent.

10. The apparatus as claimed in claim 9, wherein when said service agent receives said deregistration message, a corresponding entry of said node no longer providing streaming service to new nodes in said service list is deleted.

11. A method for transmitting streaming service, applicable to a network communication environment, said method comprising:
arranging a service agent, said service agent having a service list, said service list recording contact address of at least a node able to provide streaming service and priority of each of said at least a node on streaming data transmission path of said streaming service; and
a client node inquiring to said service agent of said contact address of said at least a node able to provide streaming service and obtaining said streaming data from said node found in the response of said inquiry.

12. The method as claimed in claim 11, said method further includes said service agent receiving registration message or deregistration message of said at least a node able to provide streaming service.

13. The method as claimed in claim 11, said method further includes all nodes found in said inquiry form a peer-to-peer network.

14. The method as claimed in claim 12, wherein when a first node sending a first request to said service agent to provide a streaming service, said method further includes:
receiving said first request to provide said streaming service;
responding to said first node that no prior record shows nodes for receiving said streaming service;
said first node receiving streaming data from original node providing said streaming service, and registering to said service agent and recording information of said streaming service that said first node is able to provide; and
taking said first node as the root node of a multicast tree.

15. The method as claimed in claim 14, wherein when said service agent receives a request to provide said streaming service from a second node, said method further includes:
inquiring to said service agent whether existing nodes able to provide said streaming service;
said second node requesting to said first node for receiving said streaming service, and constructing the second level of said multicast tree;
said second node sending a registration message to said service agent until said service agent responding with a registration success message; and
said service list recording information of said streaming service that said second node is able to provide.

16. The method as claimed in claim 12, wherein after registration of said node able to receive said streaming data failed, said failed node waits for a time and registers to said service agent again, where said waiting time is based on the priority of said node able to receive said streaming data.

17. The method as claimed in claim 13, wherein when a node departs from said peer-to-peer network or a node no longer provides streaming service to new nodes, said node sends a deregistration message to said service agent.

18. The method as claimed in claim 13, wherein when said service agent receives said de-registration message, the registration of said node is cancelled.

19. The method as claimed in claim 13, wherein when a node departs from said peer-to-peer network, said method further includes:
selecting a node randomly from all nodes served by said departing node to be responsible for receiving streaming content originally delivered to said departing node;
refreshing the level of said selected level, and re-connecting said selected node beneath to node to which said departing node originally connected to; and
connecting unselected nodes beneath to node able to continue to provide streaming service to construct a multicast tree.

20. The method as claimed in claim 19, wherein said node able to continue provide streaming service has a priority in original multicast higher than or equal to the priorities of unselected nodes in original multicast tree.

21. The method as claimed in claim 18, said method further includes deleting corresponding entry of cancelled node from said service list.
